(19) United States
(12) Patent Application Publication
(10) Pub. No.: US 2026/0177988 A1
(43) Pub. Date: Jun. 25, 2026

(54) MODULE AND TIMEPIECE EQUIPPED WITH MODULE

(71) Applicant: CASIO COMPUTER CO., LTD., Tokyo (JP)

(72) Inventor: Takamaro MIYAZAWA, Tokyo (JP)

(21) Appl. No.: 19/429,385

(22) Filed: Dec. 22, 2025

(30) Foreign Application Priority Data
Dec. 23, 2024 (JP) 2024-226117

(51) Int. Cl. G04C 17/00; G04G 9/00

(52) U.S. Cl. CPC G04C 17/0091; G04G 9/007

(57) ABSTRACT

A module including a first member, a pointer which is driven above the first member, a flexurally deformable second member, and a third member which is arranged between the first member and the second member and whose rigidity is higher than the rigidity of the first member.

### CROSS-REFERENCE TO RELATED APPLICATION

This application is based upon and claims the benefit of priority from the prior Japanese Patent Application No. 2024-226117, filed Dec. 23, 2024, the entire contents of which are incorporated herein by reference.

### BACKGROUND

### 1. Technical Field

The present invention relates to a module used in electronic devices such as wristwatches, and a timepiece equipped with the module.

### 2. Description of the Related Art

Japanese Utility-Model Application Laid-Open (Kokai) Publication No. 06-80196 discloses an electronic timepiece having a liquid crystal panel in which the liquid crystal panel that displays various types of information is provided under the lower surface side of a dial for indicating the time by pointers driven above.

### SUMMARY

An embodiment of the present invention is a module comprising: a first member; a pointer which is driven above the first member; a flexurally deformable second member; and a third member which is arranged between the first member and the second member and whose rigidity is higher than rigidity of the first member.

### BRIEF DESCRIPTION OF THE DRAWINGS

FIG. 1 is a diagram showing a wristwatch in which the present invention has been applied;

FIG. 2 is a planar view of a timepiece module mounted in the wristwatch shown in FIG. 1;

FIG. 3 is a perspective view of the timepiece module shown in FIG. 2;

FIG. 4 is an exploded perspective view of the timepiece module shown in FIG. 2; and

FIG. 5 is a cross-sectional view of the timepiece module taken along the A-A arrow view in FIG. 2.

### DETAILED DESCRIPTION OF THE PREFERRED EMBODIMENTS

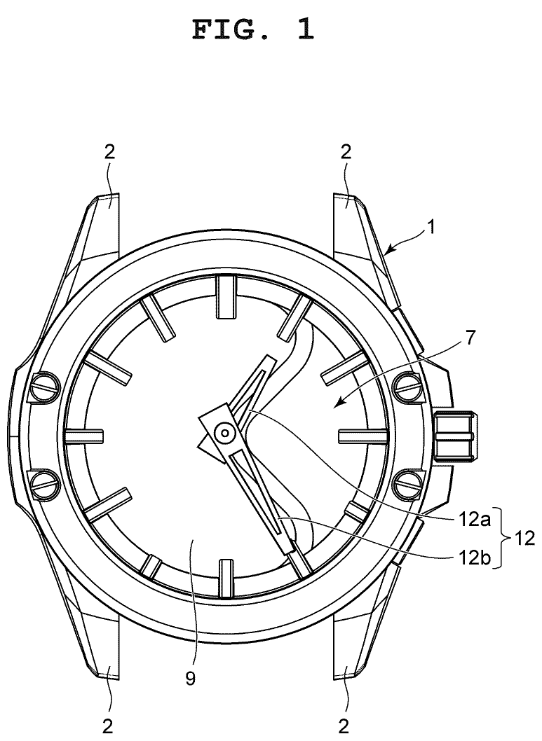

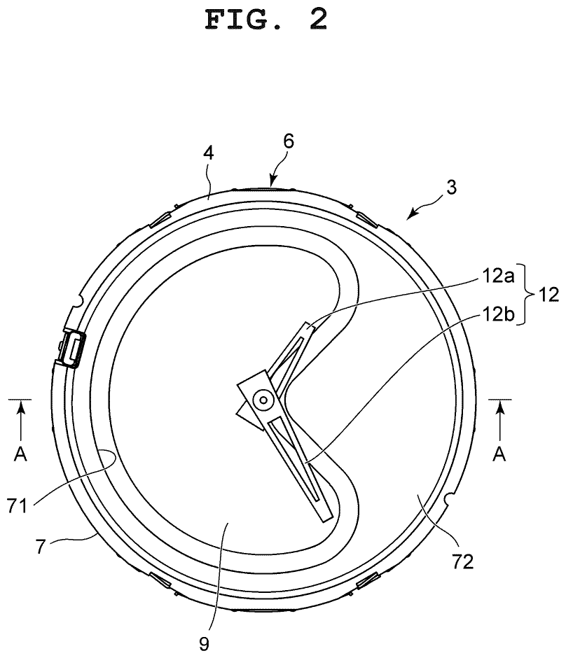

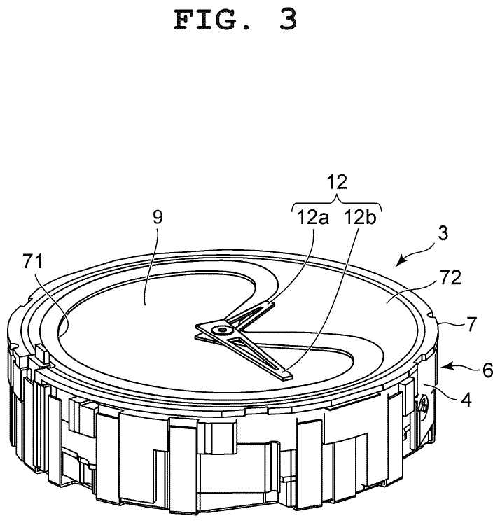

An embodiment of the present invention will hereinafter be described with reference to the drawings. FIG. 1 is a diagram showing a wristwatch in which the present invention has been applied. This wristwatch is a hybrid wristwatch which has an analog function and a digital function and includes a wristwatch case 1. On the twelve o'clock side and the six o'clock side of the wristwatch case 1, band attachment sections 2 to which wristwatch bands (not shown in the drawings) are attached are provided. Inside the wristwatch case 1, a timepiece module 3 shown in FIG. 2 to FIG. 5 is provided.

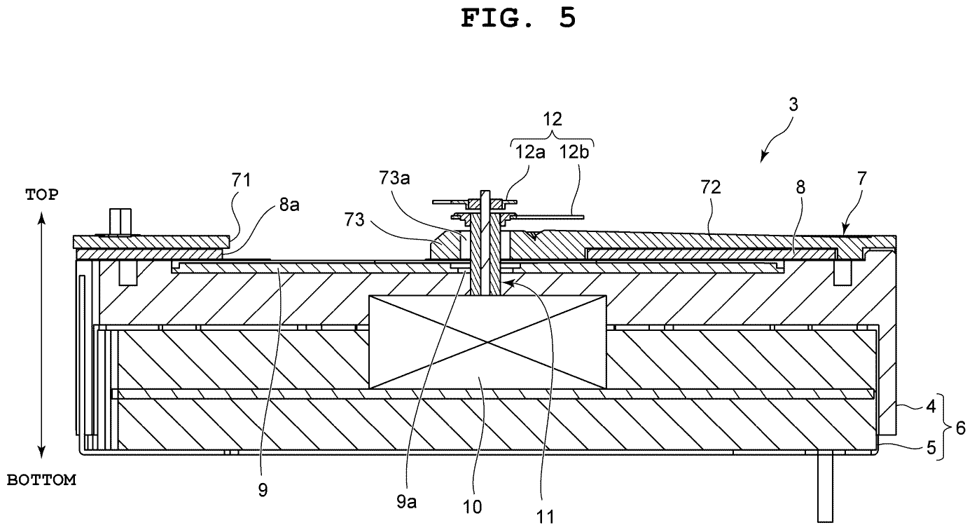

First, the outline of the timepiece module 3 is described. The timepiece module 3 includes a housing 6 constituted by an upper housing 4 and a lower housing 5, as shown in FIG. 5. The upper housing 4 is open toward the lower side, and the housing 5 is fitted into this upper housing 4 from below. On an upper surface 4a of the upper housing 4, a dial 7 is arranged. Also, under the lower surface side of the dial 7, a reinforcement plate 8 is arranged. Moreover, under the lower surface side of the reinforcement plate 8, a liquid crystal panel 9 is arranged. More specifically, the dial 7, the reinforcement plate 8 and the liquid crystal panel 9 are consecutively arranged in each thickness direction equivalent to a vertical direction in FIG. 5 which is the visual recognition direction of the wristwatch.

Inside the housing 6, a timepiece movement 10 is provided. This timepiece movement 10 includes a pointer shaft 11 which penetrates through the liquid crystal panel 9, the reinforcement plate 8 and the dial 7 to protrude above (toward the front surface side of) the dial 7, and pointers 12 such as an hour hand 12a, a minute hand 12b are attached to the protruded upper end. Also, inside the housing 6, a circuit board is mounted which constitutes an electronic circuit to control and drive the entire timepiece module 3 and various types of electronic members which are necessary for achieving timepiece functions, although not shown in FIG. 5.

Next, the dial 7, the reinforcement plate 8 and the liquid crystal panel 9 are described in detail. The dial 7 is a flexurally deformable plate-shaped member which is readily flexurally deformable in the thickness directions by an impact, and is made of a material such as plastic. In the dial 7, a display opening section 71 (a first opening section) and an overlapping section 72 are provided. The display opening section 71, which has a substantially heart shape whose area is larger than half the entire area of the dial 7, is used to expose a display area that is a part of the liquid crystal panel 9 and electrooptically displays various types of information necessary for achieving various types of functions for a wristwatch such as a date and a day of the week.

The overlapping section 72, which covers an area excluding the display area of the liquid crystal panel 9, is formed such that a portion of its outer peripheral part (ranging from the one o'clock side to the five o'clock side) is shaped to project in a gentle mountain shape toward a central portion of the dial 7, whereby the display opening section 71 is formed in a substantially heart shape. Also, the projected end portion of the overlapping section 72 located in the center of the dial 7 is provided with a penetration hole section 73 (a projection section) where a penetration hole 73a (a first hole section) is formed into which the pointer shaft 11 is inserted. A portion of the overlapping section 72 excluding the penetration hole 73, that is, a portion which constitutes a part of an opening edge portion of the display opening section 71 is inclined toward the display area.

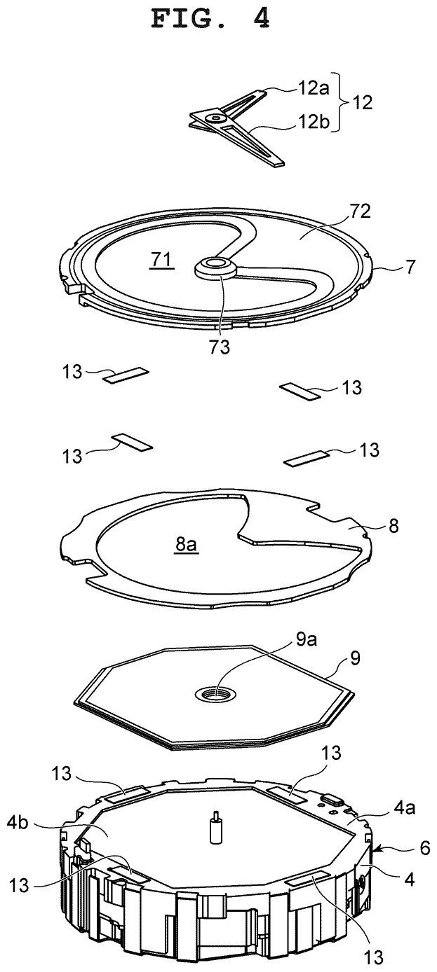

The liquid crystal panel 9 is fitted into a recess section 4b formed in the upper surface 4a of the upper housing 4, as shown in FIG. 4 and FIG. 5. This recess section 4b has an opened shape corresponding to the shape of the liquid crystal panel 9, of which the bottom surface is flat and the depth is slightly greater than the thickness of the liquid crystal panel 9. The area of the recess section 4b, that is, the area of the liquid crystal panel 9 is substantially as large as the entire area of the upper surface 4a of the upper housing 4, and has an octagonal shape. In a central portion of the liquid crystal panel 9, a penetration hole 9a (a second hole section) which is penetrated by the pointer shaft 11 of the timepiece movement 10 is provided. Since the liquid crystal panel 9 has external dimensions that are much greater than the thickness dimension and is integrally formed around the penetration hole 9a, this liquid crystal panel 9 is readily flexurally deformable in the thickness directions by an impact, as with the dial 7. Although not shown in the drawings, the liquid crystal panel 9 has a common structure including a liquid crystal cell where transparent electrodes are provided on opposing surfaces of a pair of transparent glass substrates and a gap of the pair of glass substrates is filled with liquid crystal, and a polarizing plate provided on the upper surface of the liquid crystal cell.

On the other hand, the reinforcement plate 8 arranged between the dial 7 and the liquid crystal panel 9 as described above is made of a material such as stainless steel. Unlike the dial 7 and the liquid crystal panel 9, this reinforcement plate 8 is not flexurally deformable despite being a plate-shaped member. More specifically, the reinforcement plate 8 is a rigid member whose rigidity is higher than that of the dial 7 and that of the liquid crystal panel 9. In the reinforcement plate 8, an opening section 8a (a second opening section) is provided which has a shape corresponding to that of the display opening section 71 formed in the dial 7 and whose size is slightly greater than that of the display opening section 71. As a result, the display area of the liquid panel 9 can be visually recognized through the display opening section 71 of the dial 7.

The shape and the size of the reinforcement plate 8 are substantially the same as those of the upper surface 4a of the upper housing 4, and the entire area of the outer circumferential part of the liquid crystal panel 9 is covered by the reinforcement plate 8. There is a very small gap between the back surface of the reinforcement plate 8 and the upper surface of the liquid crystal panel 9, and the reinforcement plate 8 is firmly fixed to the upper surface 4a of the upper housing 4 by double-sided adhesive tapes 13 arranged on four portions around the outer circumferential part of the above-described recess section 4b of the upper surface 4a of the upper housing 4. Similarly, the reinforcement plate 8 is firmly fixed to the back surface of the dial 7 by double-sided adhesive tapes 13 arranged on four portions of its outer circumferential part.

For example, in the case of the structure described in the above Japanese Utility-Model Application Laid-Open (Kokai) Publication No. 06-80196, if an impact is exerted thereto due to the timepiece being dropped, the liquid crystal panel may be flexurally deformed and come in contact with the dial, and the dial may be flexurally deformed to collide with the pointers, which will affect the driving of the pointers or cause the pointers to come off.

An object of the present invention is to provide a module which can suppress effects on pointers caused by the flexural deformation of flexurally deformable members as a result of an impact.

Regarding this point, in the case of the wristwatch equipped with the timepiece module 3 having the above-described structure, the dial 7 and the liquid crystal panel 9 are flexurally deformable in the thickness directions. As a result, for example, if the wristwatch is dropped onto a floor surface or the like with the pointer 12 side down, the dial 7 and the liquid crystal panel 9 are flexurally deformed toward the pointer 12 side down by an impact caused by a collision with the floor surface and the like. Here, if the impact is large, the respective degrees of flexural deformation of these members increase accordingly. In that case, in the liquid crystal panel 9, the central portion where the pointer shaft 11 penetrates is significantly deformed due to the absence of an opening section such as that in dial 7.

However, since the stainless steel reinforcement plate 8 is arranged between the liquid crystal panel 9 and the dial 7, a significant flexural deformation of the liquid crystal panel 9 toward the dial 7 side (pointer 12 side) is prevented by this reinforcement plate 8. As a result of this structure, even though the dial 7 is present between the liquid crystal panel 9 and the pointers 12 while overlapping with the entire area of the of the liquid crystal panel 9, the dial 7 is not pushed by the flexural deformation of the liquid crystal panel 9, whereby the dial 7 can be prevented from coming in contact with the pointers 12. That is, since the timepiece module 3 has the structure comprising the dial 7, the pointers 12 which are driven above the dial 7, the flexurally deformable liquid crystal panel 9, and the reinforcement plate 8 which is arranged between the dial 7 and the liquid crystal panel 9 and whose rigidity is higher than that of the dial 7, effects on the pointers 12 caused by a flexural deformation of the liquid crystal panel 9 as a result of an impact can be prevented.

Also, in the present embodiment, the pointers 12 are attached to the pointer shaft 11 which penetrates through the liquid crystal panel 9 and the dial 7 and protrudes from the front surface side of the dial 7, the dial 7 is provided with the display opening section 71 which exposes the display area of the liquid crystal panel 9 and the overlapping section 72 which forms the display opening section 71 and includes the penetration hole section 73 where the penetration hole 73a into which the pointer shaft 11 is inserted is formed, and the reinforcement plate 8 is provided with the opening section 8a which has the shape corresponding to that of the display opening section 71 and that of the penetration hole section 73. In this structure, by having the large display opening section 71, the dial 7 is more readily flexurally deformable in the thickness directions than that in the case where the display opening section 71 is not provided.

However, since a significant flexural deformation of the liquid crystal panel 9 toward the dial 7 side (the pointer 12 side) is prevented by the reinforcement plate 8 as described above, even if an impact is exerted on the dial 7 in the thickness directions, the dial 7 can be reliably prevented from coming in contact with the pointers 12. In addition, since the opening section 8a of the reinforcement plate 8 has the shape corresponding to that of the display opening section 71 of the dial 7, a flexural deformation of the liquid crystal panel 9 toward the dial 7 side (the pointer 12 side) can be reliably prevented by the reinforcement plate 8, and the liquid crystal panel 9 can be structured to have a larger (wider) display area.

Also, in the present embodiment, the overlapping section 72 of the dial 7 is shaped such that the above-described portion of the outer peripheral side of the dial 7 projects toward the central portion of the dial 7, and the penetration hole section 73 is provided in the projected end portion of the overlapping section 72 located at the center of the dial 7. Accordingly, even though the overlapping section 72 is readily flexurally deformable toward the pointer 12 side when an impact is exerted on the dial 7 in the thickness directions, since the reinforcement plate 8 is firmly fixed to the back surface of the dial 7, that is, the surface on the opposite side of the front surface which is on the pointer 12 side, a significant flexural deformation of the overlapping section 72 toward the pointer 12 side can be reliably prevented by the reinforcement plate 8. As a result of this structure, effects on the pointers 12 caused by a flexural deformation of the flexurally deformable members by an impact can be suppressed.

The dial 7 shown in the present embodiment is merely an example and similar effects can be acquired even in cases where the shapes of the display opening section 71 and the overlapping section 72 differ from those shown in the present embodiment. Also, even though the dial 7 having the single display opening section 71 has been shown in the present embodiment, a plurality of display opening sections can be provided in the dial 7 to expose display areas of a liquid crystal panel. That is, any structure can acquire similar effects as long as it includes a dial 7 whose central portion is readily flexurally deformable toward its pointer 12 side when an impact is exerted in the thickness directions, regardless of the shapes of its display opening section 71 and overlapping section 72 and the number of display opening sections 71.

Also, the reinforcement plate 8 shown in the present embodiment is merely an example and any member may be used as long as its rigidity is higher than that of the liquid crystal panel 9 and the display area of the liquid crystal panel can be visually recognized through the display opening section of the dial 7, such as a reinforcement plate made of a transparent reinforced plastic. Even in that case, since a significant flexural deformation of the liquid crystal panel 9 toward the dial 7 side (pointer 12 side) is reliably prevented by the reinforcement plate, the dial 7 can be prevented from coming in contact with the pointers 12 by an impact, whereby effects on the pointers 12 by a flexural deformation of the liquid crystal panel 9 by the impact can be eliminated.

Moreover, in the present embodiment, the timepiece module has been shown in which the dial 7, which covers the entire area of the liquid crystal panel 9 and is flexurally deformable in the thickness directions, is arranged between the pointers 12 and the liquid crystal panel 9. However, the present invention is not limited thereto, and may be applied in a module having a structure in which, for example, a flexurally deformable member (a second member), which is readily flexurally deformable in the thickness directions of a liquid crystal panel, a solar panel and the like, is arranged above a pointer which is arranged on the front surface side of a dial 7 (a first member), that is, a side which is visually recognized in a manner that the pointer and the dial 7 can be visually recognized. In that structure, a reinforcement plate (a third member) whose rigidity is higher than that of the flexurally deformable member, such as a reinforcement plate made from a transparent reinforced plastic, may be arranged between the flexurally deformable member and the pointer.

In the case of a wristwatch and the like equipped with a module having that structure, if the wristwatch is dropped onto a floor surface or the like with the back surface side down, the flexurally deformable members such as the liquid crystal panel and the solar panel are expected to be flexurally deformed toward the pointer side by an accompanying impact. However, since the reinforcement plate reliably prevents a flexural deformation of the flexurally deformable members toward the pointer side, these members do not come in contact with the pointer. Accordingly, even in the case of a structure in which flexurally deformable members are arranged on a side where a pointer is visually recognized, effects on the pointers caused by a flexural deformation of the flexurally deformable members by an impact can be suppressed.

That is, the present invention may be applied to modules comprising a first member, a pointer which is driven above the first member, a flexurally deformable second member, and a third member which is arranged between the first member and the second member and whose rigidity is higher than the rigidity of the first member, or in other words, other modules having a structure which includes a pointer and in which a second member is arranged on a side where the pointer is visually recognized or on its opposite side. In addition, the module of the present invention is not necessarily required to be used in a wristwatch and may also be used in other devices that include a pointer.

While the present invention has been described with reference to the preferred embodiments, it is intended that the invention be not limited by any of the details of the description therein but includes all the embodiments which fall within the scope of the appended claims.

What is claimed is:

1. A module comprising:
a first member;
a pointer which is driven above the first member;
a flexurally deformable second member; and
a third member which is arranged between the first member and the second member and whose rigidity is higher than rigidity of the first member.

2. The module according to claim 1, wherein the second member is a liquid crystal panel,
wherein the pointer is attached to a pointer shaft which penetrates through a second hole section formed in the liquid crystal panel, and
wherein the liquid crystal panel is integrally formed around the second hole section.

3. The module according to claim 1, wherein the first member is flexurally deformable in thickness directions, arranged between the pointer and the third member, and overlaps with the second member.

4. The module according to claim 2, wherein the pointer is attached to the pointer shaft which penetrates through a first hole section formed in the first member and protrudes from a front surface side of the first member.

5. The module according to claim 4, wherein the first member includes an overlapping section in which the first hole section is formed, and has formed therein a first opening section which exposes a display area of the second member.

6. The module according to claim 5, wherein the third member has formed therein a second opening section whose shape corresponds to shape of the first opening section of the first member.

7. The module according to claim 6, wherein the first opening section is formed larger than the second opening section.

8. The module according to claim 5, wherein a portion of the overlapping section of the first member on an outer peripheral side of the first member is shaped to project toward a central portion, a projection section is provided on a projected end portion of the overlapping section which is located at the central portion of the first member, and the first hole section is formed in the projection section.

9. The module according to claim 1, wherein the third member is fixed to a back surface of the first member which is on a side opposite to a front surface on the pointer side.

10. A timepiece comprising the module according to claim 1.

11. The timepiece according to claim 10, wherein the pointer, the first member, the second member, and the third member are arranged in order of the pointer, the first member, the third member, and the second member from a side which is visually recognized by a user.

12. The timepiece according to claim 10, wherein the pointer, the first member, the second member, and the third member are arranged in order of the second member, the third member, the pointer, and the first member from a side which is visually recognized by a user.
